(19) United States
(12) Patent Application Publication
(10) Pub. No.: US 2021/0253327 A1
(43) Pub. Date: Aug. 19, 2021

(54) DEVICES AND METHODS FOR THAWING BIOLOGICAL MATERIAL

(71) Applicant: Celularity Inc., Florham Park, NJ (US)

(72) Inventors: Brian Murphy, Livingston, NJ (US); Robert J. Hariri, Bernardsville, NJ (US)

(73) Assignee: Celularity Inc., Florham Park, NJ (US)

(21) Appl. No.: 17/302,353

(22) Filed: Apr. 30, 2021

Related U.S. Application Data
(63) Continuation of application No. 16/011,599, filed on Jun. 18, 2018, now abandoned.
Application No. 16/011,599 is a continuation of application No. 14/380,018, filed on Aug. 20, 2014, now abandoned.
(60) Provisional application No. 61/601,406, filed on Feb. 21, 2012.

(51) Int. Cl. B65D 81/18; F24V 30/00; B01L 7/00; B65D 25/04

(52) U.S. Cl. CPC B65D 81/18; F24V 30/00; B01L 9/06; B65D 25/04; B01L 2300/123; B01L 7/00

(57) ABSTRACT

Provided herein are devices and methods for thawing frozen biological material.

### 1. INTRODUCTION

Provided herein are devices and methods for thawing frozen biological material.

### 2. BACKGROUND

Frozen biological material (e.g., cells) is regularly used in both laboratory and clinical settings. However, upon thawing such biological material, it is often difficult to obtain consistent results (e.g., in terms of cell viability, etc.) due to varying and non-ideal conditions under which the biological material is thawed. Therefore, there remains a need for devices which can safely and rapidly thaw biological material in a manner that maintains the optimal condition of the biological material.

### 3. SUMMARY

Provided herein are improved devices for thawing frozen biological material (e.g., cells). The devices described herein are designed to ensure that the container (e.g., a tube, vial, or bag) which holds the frozen biological material to be thawed is consistently and thoroughly in contact with the source of heat and thus promotes rapid thawing of the biological material. The devices described herein comprise controllable temperature settings, so that they may be utilized at any thawing temperature desired by the individual using the device (e.g., 1° C., 2° C., 4° C., 5° C., 6° C., 7° C., 8° C., 9° C., 10° C. 11° C., 12° C., 13° C., 14° C., 15″C., 16° C., 17° C., 18° C., 19° C., 20° C., 21° C., 22° C. 23° C., 24° C., 25° C., 26° C., 27° C., 28″C., 29° C., 30° C., 31° C., 32″C., 33° C., 34° C., 35° C., 36° C., 37° C., 38° C., 39° C., 40° C., 41° C., 42° C., 43° C., 44° C., 45° C., 46° C., 47° C., 48° C., 49° C., 50° C., etc.), and also so that the temperature can be increased or decreased during the thawing process (e.g., We temperature can be increased or decreased in 1, 2, 3, 4, 5 or more degree intervals by, e.g.. pressing a button). In certain embodiments, the devices described herein additionally comprise one or more components that enable agitation (e.g., gentle shaking or rotation) of the biological material to be thawed during the thawing process.

In one embodiment, provided herein is an improved thawing apparatus, wherein said apparatus comprises one or more compartments into which a container comprising frozen biological material may be thawed., wherein said one or more compartments comprise compressible material (e.g., compressible gasket material). Such thawing apparatuses are advantageous in that they can accommodate biological material containers (e.g., tubes or vials) of varying sizes, and also ensure that the containers (e.g., tubes or vials) that contain the biological material to he thawed are thoroughly in contact with the heat source. In certain embodiments, the improved thawing apparatuses comprising compressible material described herein are similar in design to dry block thawing apparatuses known in the art, but possess the advantage of comprising compressible material.

In another embodiment, provided herein is an improved thawing apparatus, wherein said apparatus comprises one or more compartments into which a container comprising frozen biological material may he thawed, wherein said one or more compartments comprises a cuff which can be placed around containers (e.g., tubes or vials) of varying size and manipulated so that it comes into thorough contact with the container. Such cuffs can be filled with a heated substance (e.g., heated fluid), the levels of which can be adjusted (e.g., tilled with more or less fluid) to ensure accommodation of containers of varying size and to ensure that thorough contact between the container and the heating source. Alternatively, such cuffs may comprise a heated material which can be expanded by the application of pressure (e.g., air pressure; fluid pressure, e.g., oil pressure, water pressure, or the like) to ensure accommodation of containers of varying size and to ensure that thorough contact between the container and the heating source. In certain embodiments, the improved thawing apparatuses comprising cuffs described herein are similar in design to dry block thawing apparatuses known in the art, but possess the advantage of comprising cuffs, the size of which can be modified/adjusted.

In another embodiment, provided herein is an improved thawing apparatus, wherein said apparatus comprises (i) a sealed compartment comprising material that undergoes a phase change when heated to a certain temperature paraffin or beeswax), (ii) a compartment into which a source of heat (e.g., boiling water) can be added, and (iii) at least one compartment into which a container (e.g., tube or vial) containing biological material can be placed. The improved thawing apparatus functions as follows: (i) the phase change of the phase change material is effected by addition of a heat source to the appropriate compartment of the apparatus, e.g., by adding boiling water to the compartment of the apparatus; (ii) once the phase change material has reached its melting point, the container(s) (e.g., tube or vial) containing the biological material to be thawed is then placed into the appropriate compartment of the apparatus; and (iii) as the frozen material cools the phase change material, the phase change material will remain at is melting point, which is suitable to result in the thawing of the biological material,

In another embodiment, provided herein is an improved thawing apparatus, wherein said apparatus comprises (i) a sealed compartment comprising a chemical material (e.g., iron) that eats to a certain temperature following exposure to a given condition (e.g., exposure to oxygen) and (ii) at least one compartment O which a container (e.g., tube or vial) containing biological material can be placed. The improved thawing apparatus functions as follows: (i) the apparatus is heated by exposing the chemical material to a given condition (e.g., oxygen); and (ii) once the apparatus is at its desired temperature, the container(s) (e.g., tube or vial) containing the biological material to be thawed is then placed into the appropriate compartment of the apparatus; resulting in the thawing of the biological material.

### 4. DESCRIPTION OF THE DRAWINGS

FIG. 1 is a perspective view of an exemplary thawing apparatus of the present invention having compressible material disposed in the compartments.

FIGS. 2 and 3 are perspective sectional views of the thawing apparatus of FIG. 1 taken along the view line F2, wherein the apparatus illustrated in FIG. 3 has a container inserted in a compartment,

FIG. 4 is a perspective view of an exemplary thawing apparatus of the present invention having cuffs disposed in the compartments.

FIGS. 5 and 6 are perspective sectional views of the thawing apparatus of FIG. 4 taken along the view line F5, wherein the apparatus illustrated in FIG. 6 has a container inserted in a compartment.

FIGS. 7 and 8 are perspective of an exemplary thawing apparatus of the present invention having cuffs, wherein disposed outside the cuffs in a contracted or deflated condition in FIG. 7 and the container is disposed inside the cuffs in an expanded or inflated condition in FIG. 8.

FIG. 9 is a perspective view of an exemplary thawing apparatus of the present invention having a phase change material.

FIG. 10 is a perspective sectional view of the thawing apparatus of FIG. 9 taken along the view line F10.

FIG. 11 is a perspective sectional view of alternative thawing apparatus taken along the view line F10.

FIG. 12 is a perspective view of an exemplary thawing apparatus of the present invention having a chemical material.

FIG. 13 is a perspective sectional view of the thawing apparatus of FIG. 12 taken along the view line F13.

FIG. 14 is a perspective sectional view of an alternative thawing apparatus taken along the view line F13 and having controllable mechanisms.

FIG. 15 is a perspective sectional view of an alternative thawing apparatus taken along the view line F13 and having controllable mechanisms and a controller operatively coupled to an external computer.

### 5. DETAILED DESCRIPTION

Provided herein are improved devices for thawing frozen biological material (e.g., cells). The devices described herein are designed to ensure that the container (e.g., tube or vial) which holds the frozen biological material to be thawed is consistently and thoroughly in contact with the source of heat and thus promotes rapid thawing of the biological material. The devices described herein comprise controllable temperature settings, so that they may be utilized at any thawing temperature desired by the individual using the device (e.g., 23° C., 37° C., 50° C., 100° C., etc.), and also so that the temperature can be increased or decreased during the thawing process (e.g., the temperature can be increased or decreased in 1, 2, 3, 4, 5 or more degree intervals by, e.g., pressing a button), in certain embodiments, the devices described herein additionally comprise one or more components that enable agitation (e.g., gentle shaking or rotation) of the biological material to be thawed during the thawing process.
5.1 Improved Thawing Apparatuses

Dry block thawing apparatuses currently known in the art are problematic in that the compartments into which the biological material containers are placed are static, i.e., they are generally made of solid metal and are thus not able to accommodate containers (e.g., tubes or vials) of varying sizes. This design leads to various problems, including containers (e.g., tubes or vials) becoming stuck in the compartments into which they are placed (due to the tubes being too large for the compartment) or containers (e.g., tubes or vials) loosely fitting into the compartments they are placed (due to the tubes being too small for the compartment). Moreover, dry block thawing apparatuses currently known in the art do not promote ideal contact of the biological material containers with the source of heat, and this issue is worsened in cases where the containers loosely fit in the compartments of the dry block thawing apparatus.

Water bath thawing apparatuses currently known in the art also are problematic for various reasons. First, water bath thawing apparatuses typically require that the container that contains the biological material to be thawed is often not exposed to an ideal amount of the heat source, similar to the situation with known dry block thawing apparatuses. Further, water bath thawing apparatuses known in the art are very likely to become contaminated, thus introducing the risk that the biological material to be thawed also will become contaminated.

The improved thawing apparatuses described herein overcome the issues that occur with known dry block thawing apparatuses and water bath thawing apparatuses, as well as other thawing apparatuses known in the art by, without limitation: (i) promoting significantly greater amount of contact between the container (e.g., tube or vial) that contains the biological material than that which occurs with thawing apparatuses currently known in the art; and (ii) being able to accommodate containers of various sizes.

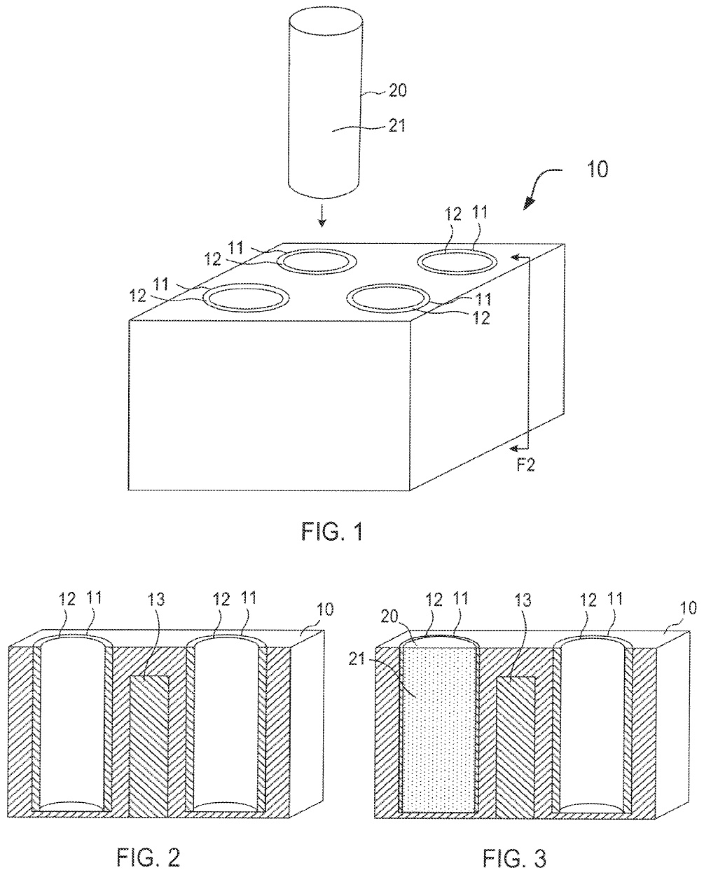

Referring to FIGS. 1 to 3, an exemplary thawing apparatus having compressible material, e.g., compressible material with a high heat transfer coefficient or high heat conduction, is provided in accordance with the principles of the present invention. Thawing apparatus 10 includes a plurality of compartments 11 having compressible material 12 disposed therein, and heating element 13. Each compartment 11 may be configured to receive container 20 comprising frozen biological material 21. Compressible material 12 (e.g., compressible gasket material) is configured to line compartment 11 as illustrated in FIGS. 1 and 2 and to compress when container 20 is inserted in compartment 11 as illustrated in FIG. 3, Heating element 13 may he a conventional heating element and is configured to heat thawing apparatus 10 to a. temperature suitable to thaw frozen biological material 21 disposed in container 20. Thawing apparatus 10 may advantageously accommodate one or more biological material containers tubes or vials) of varying sizes, and. also ensure that the containers (e.g., tubes or vials) having the biological material to be thawed are thoroughly in contact with the heat from apparatus 10. In certain embodiments, the improved thawing apparatuses comprising compressible material described herein are similar in design to dry block thawing apparatuses known in the art, but possess the advantage of comprising compressible material. In certain embodiments, the compressible material is a known compressible gasket material. In a specific embodiment, the compressible material is silicone, rubber, or sponge (or a combination thereof).

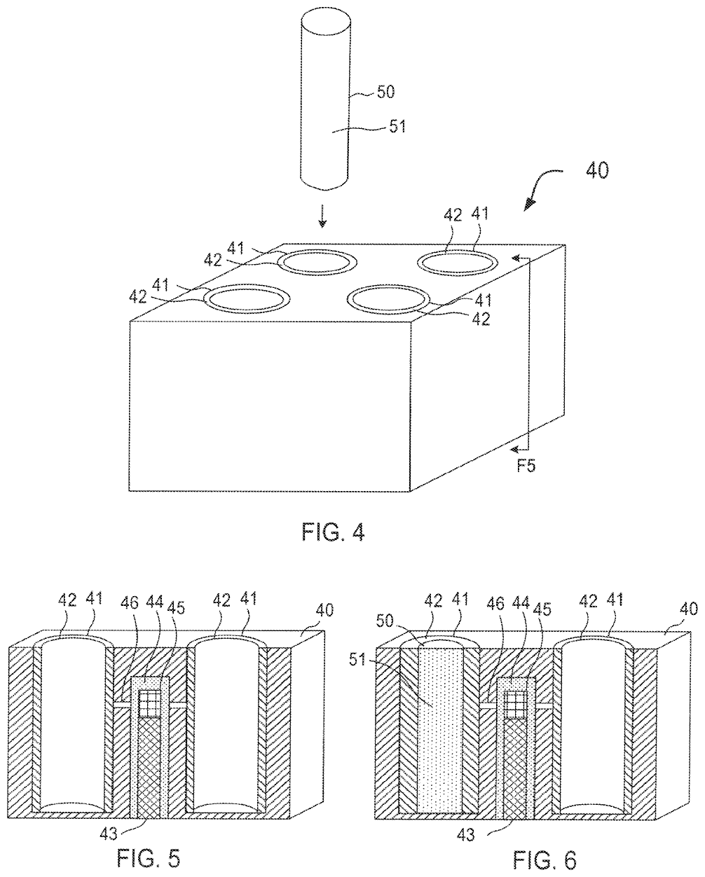

Referring now to FIGS. 4 to 6, an alternative exemplary thawing apparatus having cuffs is provided in accordance with the principles of the present invention. Thawing apparatus 40 includes a plurality of compartments 41 each having cuff 42 disposed therein, heating element 43, pump fluid 44, pump 45, and channels 46. Each compartment 41 may be configured to receive container 50 comprising frozen biological material 51. Cuff 42 is configured to line compartment 41 as illustrated in FIGS. 4 and 5 and to expand when container 50 is inserted in compartment 41 as illustrated in FIG. 6 by pumping pump fluid 44 using pump 45 into cuff 42 through respective channel 46. Heating element 43 may be a conventional heating element disposed in or near pump fluid 44 and is configured to heat pump fluid 44 to a temperature suitable to thaw frozen biological material 51 disposed in container 50. Alternatively, heating element 43 may be disposed outside of pump fluid 44 and configured to heat apparatus 40 to thaw frozen biological material 51. Pump 45 may be a conventional pump and is configured to pump fluid 44 to and from a respective cuff 42 using a respective channel 46 to cause the cuff to expand or contract. As will be apparent to one of ordinary skill in the art, pump 45 and/or channels 46 may include one or more valves suitable for controlling flow of pump fluid 44 to or from cuffs 42. Containers (e.g., tubes or vials) of varying size may be placed in compartments 41 and cuffs 42 may be manipulated to come into contact with the container. In one embodiment, such cuffs may comprise a heated material which may be expanded by the application of pressure (e.g., air pressure; fluid pressure, e.g., oil pressure, water pressure, or the like) to ensure accommodation of containers of varying size and to ensure that thorough contact between the container and the heating source. In certain embodiments, the improved thawing apparatuses comprising cuffs described herein are similar in design to dry block heating/warming apparatuses known in the art, but possess the advantage of comprising cuffs, the size of which can be modified/adjusted.

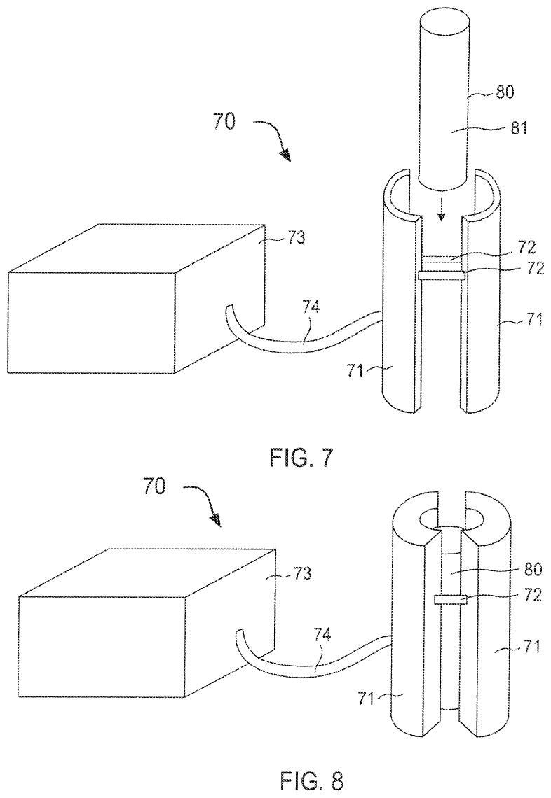

Referring now to FIGS. 7 to 8, another alternative exemplary thawing apparatus having cuffs is provided in accordance with the principles of the present invention. Thawing apparatus 70 includes at least one cuff 71, connectors 72, fluid source pump 73, and at least one tube 74. Cuff 71 is configured to receive container 80 comprising frozen biological material 81. As will be apparent to one of ordinary skill in the art, more than one cuff 71 may be used as illustrated and connected via connectors 72 or one cuff shaped and sized to receive container 80 may be used. Fluid source pump 73 is configured to store fluid and may include a conventional heating element for heating the fluid and a conventional pump for pumping the heated fluid to cuff(s) 71 through tube 74 and optionally to more than one cuff 71 through connectors 72. Cuff 71 is configured to contract when fluid is pumped therefrom as illustrated in FIG. 7 and to expand when fluid is pumped therein as illustrated in FIG. 8. Cuffs 71 may be placed around containers (e.g., tubes or vials) of varying size and manipulated to come into contact with the container. In one embodiment, such cuffs may comprise a heated material which may be expanded by the application of pressure (e.g., air pressure) to ensure accommodation of containers of varying size and to ensure that thorough contact between the container and the heating source.

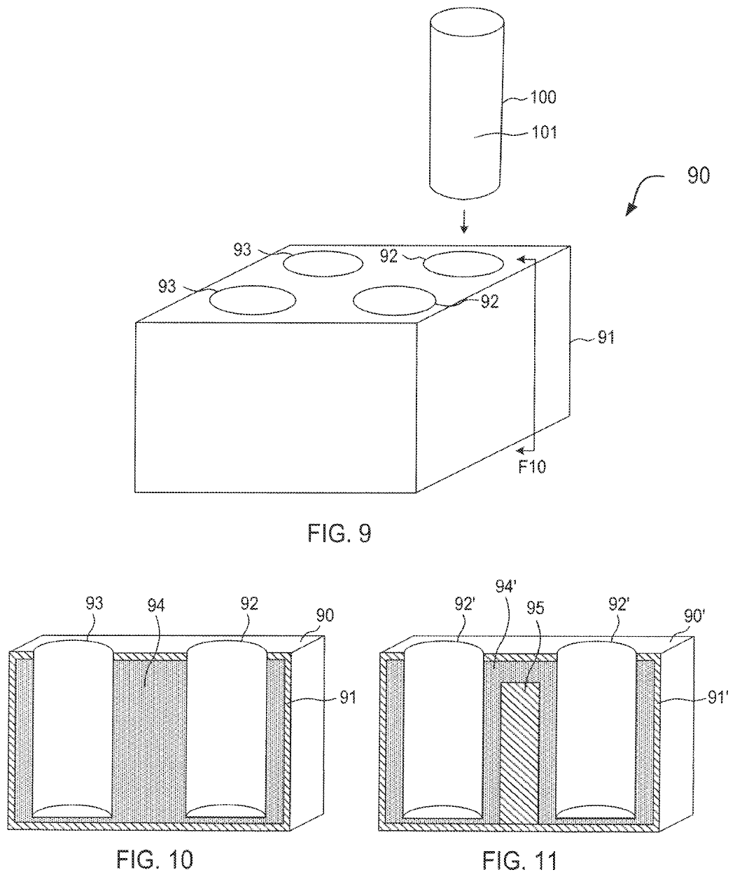

Referring now to FIGS. 9 to 10, yet another exemplary thawing apparatus is provided in accordance with the principles of the present invention. Thawing apparatus 90 includes housing 91, a plurality of compartments 92, a plurality of heating compartments 93, and phase change material 94. Each compartment 92 may be configured to receive container 100 comprising frozen biological material 101. Housing 91 is configured to seal phase change material 94 therein. Each heating compartment 93 is configured to receive a heated material (e.g., boiling water) at a temperature suitable to cause phase change material 94 (e.g., paraffin or beeswax) to undergo a phase change. Thawing apparatus 90 may function as follows; (i) the phase change of phase change material 94 is effected by addition of a heat source to heating compartment 93 of apparatus 90, e.g., by adding boiling water to the compartment of the apparatus; (ii) once phase change material 94 has reached its melting point, container(s) 100 (e.g., tube or vial) containing frozen biological material 101 to be thawed is then placed into compartment 92 of apparatus 90; and (iii) as frozen biological material 101 cools phase change material 94, phase change material 94 remains at is melting point, which is suitable to result in the thawing of the frozen biological material.

Referring to FIG. 11, thawing apparatus 90′ is constructed substantially identically to thawing apparatus 90 of FIGS. 9 and 10, wherein like components are identified by like-primed reference numbers. Thus, for example, housing 91′ in FIG. 11 corresponds to housing 91 of FIGS. 9 and 10, etc. As will be observed by comparing FIGS. 10 and 11, apparatus 90′ does not include heating compartment 93 and includes heating element 95. Heating element 95 may be disposed in or near phase change material 94′ and may be a conventional heating element configured to heat phase change material 94′ to a suitable temperature to cause phase change material 94′ to undergo a phase change.

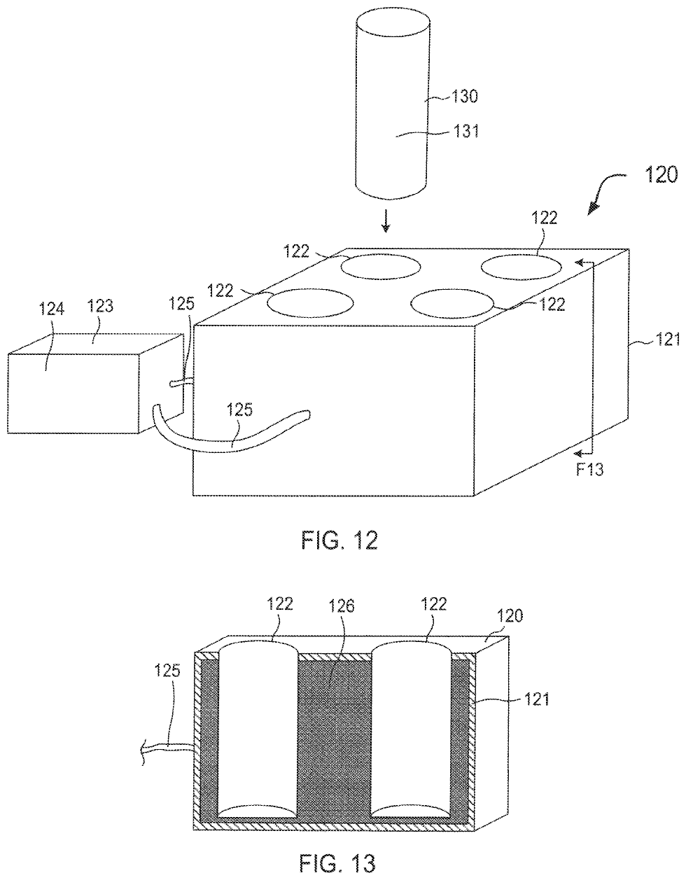

Referring now to FIGS. 12 to 13, an alternative exemplary thawing apparatus having a chemical material is provided in accordance with the principles of the present invention. Thawing apparatus 120 includes housing 121, a plurality of compartments 122, reactant source pump 123 having reactant 124, tube(s) 125 and chemical material 126. Each compartment 122 may be configured to receive container 130 comprising frozen biological material 131. Housing 121 is configured to seal chemical material 126 therein. Reactant source pump 123 is configured to store reactant 124 (e.g., oxygen) and may include a conventional pump for pumping reactant 124 to chemical material 126 (e.g., iron) through tube(s) 125. Chemical material 126 is configured to heat to a suitable temperature to thaw frozen biological material 131 following exposure to a given condition (e.g., exposure to a reactant such as oxygen from reactant source pump). Thawing apparatus 120 may function as follows: (i) chemical material 126 is heated by exposing chemical material 126 to a given condition (e.g., reactant from reactant pump source); and (ii) once the apparatus is at its suitable temperature, container(s) 130 (e.g., tube or vial) containing biological material 131 to be thawed is then placed into the appropriate compartment 122 of apparatus 120; resulting in the thawing of biological material 131. In a specific embodiment, the chemical material is iron and the given condition is exposure to oxygen. in another specific. embodiment, the chemical material is sodium acetate. In another specific embodiment, the chemical material is liquefied petroleum gas (lpg) and the given condition is exposure to platinum.

In certain embodiments, the improved thawing apparatuses described herein result in a 5%, 10%, 15%, 20%, 25%, 30%, 35%, 40%, 45%, 50%, or greater than 50% increase in contact between the container (e.g., tube or vial) that contains the biological material than that which occurs with a thawing apparatus currently known in the art (e.g., a standard dry block thawing apparatus or a standard water bath thawing apparatus).

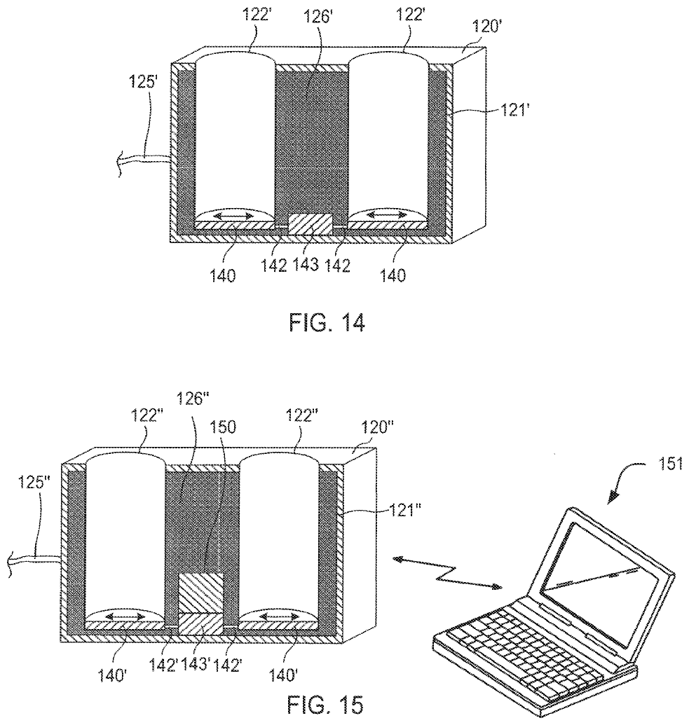

Referring to FIGS. 14 and 15, thawing apparatuses 120′ and 120″ are constructed. substantially identically to thawing apparatus 120 of FIGS. 12 and 13, wherein like components are identified by like-primed reference numbers. Thus, for example, housing 121′ in FIG. 14 and housing 121″ in FIG. 15 correspond to housing 121 of FIGS. 12 and 13, etc. As will be observed by comparing FIGS. 13 and 14, apparatus 120′ further includes one or more controllable mechanisms 140 coupled by at least one shaft 142 to motor 143. Controllable mechanisms 140 are configured to agitate container(s) 130 (e.g., tube or vial) containing biological material 131 to be thawed. Motor 143 may be a conventional motor configured to agitate controllable mechanism 140 by moving shaft(s) 142. In one embodiment, motor 143 is configured to agitate controllable mechanism 140 so as to shake container(s) 130 (e.g., tube or vial) containing biological material 131 to be thawed, e.g., shakes the container up and down or left to right as illustrated, or both. In another embodiment, motor 143 is configured to agitate controllable mechanism 140 to rotate container(s) 130 (e.g., tube or vial) containing biological material 131 to be thawed, e.g., the controllable mechanism rotates the container in a clockwise or counter-clockwise manner.

As will be observed by comparing FIGS. 14 and 15, apparatus 120″ further includes controller 150 for controlling components of thawing apparatus 120″ including motor 143′. Controller 150 may include any one or more microprocessors, controllers, digital signal processors (DSPs), application specific integrated circuits (ASICs), field-programmable gate arrays (FPGAs), or equivalent discrete or integrated digital or analog logic circuitry, and the functions attributed to controller 150 herein may be embodied as software, firmware, hardware, or any combination thereof Controller 150 may include a memory for storing data related to use of thawing apparatus 120″, such as a selected program for agitating container(s). The memory may store program instructions that, when executed by controller 150, cause controller 150 and apparatus 120″ to provide the functionality ascribed to them herein. The memory of controller 150 also may store software downloaded thereon or implemented as a program product and stored on a tangible storage device such as machine-readable medium, e.g., tape, compact disk (CD), digital versatile disk (DVD), blu-ray disk (BD), flash drive, and so forth., external nonvolatile memory device, cloud storage, or other tangible storage medium. The software may include computer executable instructions for controlling apparatus 120″. Optionally, controller 150 may include suitable components for wired and/or wireless communication with external computer 151, illustratively a laptop computer, External computer 151 may have software downloaded thereon for controlling apparatus 120″. In one embodiment, the software on external computer 151 allows a practitioner (e.g. a lap technician) to select a predefined program and/or create a program for agitating container(s). As will be readily apparent, thawing apparatus 120″ and external computer 151 are not to scale.

In certain embodiments the apparatuses described herein comprise controllable temperature settings, so that they may be utilized at any thawing temperature desired by the individual using the device (e.g., 23° C., 37° C., 50° C., 100° C., etc.), and also so that the temperature can be increased or decreased during the thawing process (e.g., the temperature can be increased or decreased in 1, 2, 3, 4, 5 or more degree intervals by, e.g., pressing a button), in certain embodiments, the apparatuses described herein can be programmed to thaw at a specific temperature (e.g. 42° C.) for a specific period of time, followed by a shift to a different temperature (e.g.. 37° C.) for a specific period of time.

In certain embodiments, the apparatuses describe(herein comprise one or more methods for alerting the practitioner that the thawing cycle of a certain biological material has been completed, e.g., the apparatus may comprise a bell, a buzzer, a flashing light or any combination thereof, or any other similar alerting mechanism. In certain embodiments, the device may comprise instructions for thawing certain frozen biological materials that are frozen in a specific volume, and also may provide times for which said frozen biological materials that are frozen in a specific volume will be thawed using the apparatus.

The duration of time for thawing of a biological material using a thawing apparatus described herein will depend on a variety of factors including, without limitation, the volume of the frozen biological material, the thawing apparatus used, whether or not the practitioner wishes to agitate (e.g., rotate or shake) the container containing the biological material, and the temperature the practitioner desires to thaw at. Those of skill in the art will appreciate how the improved thawing apparatuses can be adjusted to accommodate the desired timing and degree of thawing.

As will be apparent to one of ordinary skill in the art, components of the thawing apparatuses described herein may be used separately or in combination with one another. For example, controllable mechanism(s) 140′, shaft(s) 142′, motor 143′, and/or controller 150 of FIG. 15 may be incorporated in thawing apparatus 10, thawing apparatus 40, thawing apparatus 70, and/or thawing apparatus 90, etc. without departing from the principles of the present invention.
5.2 Containers

Any container suitable for freezing biological material can be used in the thawing apparatuses described herein. In certain embodiments, the containers comprise tubes. In certain embodiments, the containers comprise vials. In certain embodiments, the containers comprise bags. Such containers may be made of any material known in the art, glass, plastic, polystyrene, etc.

The containers be used in the thawing apparatuses described herein may be of any size known in the art. In certain. embodiments, the containers have a volume of 100 μl to 500 μl, 500 μl to 1 ml, 1 ml to 2 ml, 1 ml to 5 ml, 5 ml to 10 ml, 10 ml to 25 ml, 25 ml to 50 ml, 50 ml to 100 ml, or 100 ml to 1 L. In certain embodiments the containers have a volume of more than 1 L.
5.3 Biological Material

Any biological material can be thawed in a container using the thawing apparatuses described herein. In a specific embodiment, the biological material comprises cells, e.g., cryopreserved cells, in another specific embodiment, the biological material comprises intact tissue or organ. In another specific embodiment, the biological material comprises blood, e.g., human or animal blood.

The devices and methods disclosed herein are not to be limited in scope by the specific embodiments described herein. Indeed, various modifications of the devices arid methods in addition, to those described will become apparent to those of skill in the art from the foregoing description and accompanying figures. Such modifications are intended to fall within. the scope of the appended claims.

1. A thawing apparatus comprising one or more compartments into which a container comprising frozen biological material may be thawed, wherein said one or more compartments comprise compressible material, or wherein said one or more compartments comprises a cuff which fits around the container.

2. (canceled)

3. A thawing apparatus comprising: (i) a sealed compartment comprising material that undergoes a phase change when heated to a certain temperature, (ii) a compartment into which a source of heat can be added, and (iii) at least one compartment into which a container containing biological material can be placed.

4. (canceled) A thawing apparatus comprising: (i) a sealed compartment comprising a chemical material that heats to a certain temperature following exposure to a given condition and (ii) at least one compartment into which a container containing biological material can be placed.

5. The thawing apparatus of claim 1, wherein said compressible material comprises rubber, silicone, or sponge.

6. The thawing apparatus of claim 1, wherein said cuff is filled with fluid.

7. The thawing apparatus of claim 3, wherein said material is paraffin or beeswax.

8. The thawing apparatus of claim 3, wherein said source of heat is heated water.

9. The thawing apparatus of claim 4, wherein said chemical material is iron and wherein said given condition is exposure to oxygen.

10. The thawing apparatus of claim 4, wherein said chemical material is sodium, acetate.

11. The thawing apparatus of claim 4, wherein said chemical material is liquefied petroleum gas (lpg) and wherein said given condition is exposure to platinum.
